(19) United States
(12) Patent Application Publication
(10) Pub. No.: US 2005/0199238 A1
(43) Pub. Date: Sep. 15, 2005

(54) Mask with grooved baffle

(76) Inventor: Shuei-Wun Ciou, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/076,974

(22) Filed: Mar. 11, 2005

(30) Foreign Application Priority Data
Mar. 12, 2004 (TW) 93203810

(51) Int. Cl. A62B 9/02; A62B 18/02

(52) U.S. Cl. 128/205.25

(57) ABSTRACT

A mask with grooved baffle is disclosed. The mask includes a cover, a strip and a baffle mounted at an inner side of the cover. The baffle separates the cover into two parts, an upper part and a lower part. The baffle is formed with a grooved section at the top, which includes a plurality of wave shape grooves for air flowing therethrough. The grooved section extends from one end of the baffle to the other end. When the user wears the mask, the baffle is positioned under the nose of the user, such that air flows smoothly to the nose through the grooves. The cover has a fixed structure or a foldable flat shape structure.

### FIELD OF THE INVENTION

The present invention relates to a mask, especially to a mask with grooved baffle.

### BACKGROUND OF THE INVENTION

In the past few decades, many new diseases emerge, for example, Severe Acute Respiratory Syndrome (SARS). Some of these diseases are highly infectious and fatal. To prevent from infection, people are recommended to stay at clean and safe places, to wash hands frequently and to put on masks. Commercially, there are a variety of masks or respirators, which are able to fulfill different purposes. These masks are generally of foldable flat shape or partial spherical shape for putting on the user's face and screening the germs in the air and preventing the germs from flowing to the user's mouth and nose. A cavity is formed between the mask and the user's face. Anyway, these masks are usually formed integrally, and do not include partition for separating the nose from the mouth.

Normally, when the user coughs, the air coming out from his mouth is full of germs. If the patient wears a mask or respirator, the germs are kept in the cavity between the mask and the user's face. Inevitably, when the user breathes, the germs will flow to the user's nose along with the air. In other words, the user continually breathes in infectous air. It is desired to have a mask that can prevent the user from breathing in the germs.

### SUMMARY OF THE INVENTION

Thus, the primary purpose of the present invention is to provide a mask with a baffle. The baffle is formed with a grooved section at the top and is mounted at an inner side of the mask. The baffle comprises at lease one groove that allows air to flow through smoothly.

Another purpose of the present invention is to provide a mask with a baffle which acts as a partition for separating the nose from the mouth. For user who has infectious disease, the germs coughed out from the user's mouth are kept from flowing to the nose.

To achieve the above objects, in accordance with the present invention, there is provided a mask with grooved baffle. The mask includes a cover, a strip and a baffle mounted at an inner side of the cover. The baffle separates the cover into two parts, an upper part and a lower part. The baffle is formed with a grooved section at the top, which includes a plurality of wave shape grooves for air flowing therethrough. The grooved section extends from one end of the baffle to the other end. When the user wears the mask, the baffle is positioned under the nose of the user, such that air flows smoothly to the nose through the grooves. The cover has a fixed structure or a foldable flat shape structure.

### BRIEF DESCRIPTION OF THE DRAWINGS

FIG. 1 is a rear perspective view of a mask with grooved baffle constructed in accordance with a first embodiment of the present invention;

FIG. 2 is an exploded view of the mask of the present invention;

FIG. 3 is a sectional view showing a baffle of the mask of the present invention;

FIG. 4 is a side view showing a user puts on the mask of the present invention; and

FIG. 5 is an exploded view of the mask with grooved baffle constructed in accordance with a second embodiment of the present invention.

### DETAILED DESCRIPTION OF THE PREFERRED EMBODIMENTS

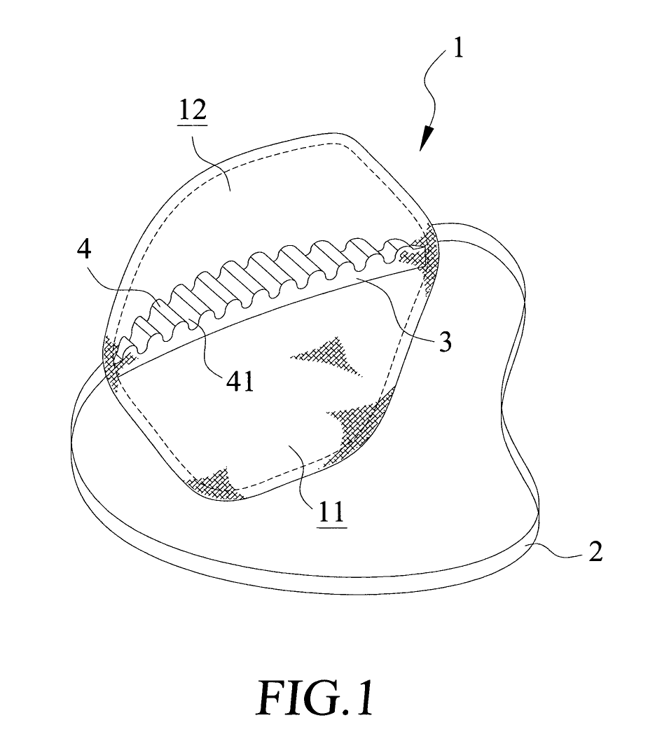

Please refer to FIG. 1. A mask with grooved baffle constructed in accordance with a first embodiment of the present is shown. The mask comprises a cover 1, a strip 2 and a baffle 3. The cover 1 is roughly circular shape with a depression, forming an internal space. The two ends (not labeled) of the strip 2 are respectively mounted to two opposing points at the middle part of the cover 1, for fastening the cover 1 to the user. The baffle 3 is mounted at an inner side of the cover 1.

As shown, the baffle 3 separates the cover 1 into two parts, an upper part 12 and a lower part 11. The baffle 3 is formed with a grooved section 4 at the top, which comprises a plurality of wave shape grooves 41.

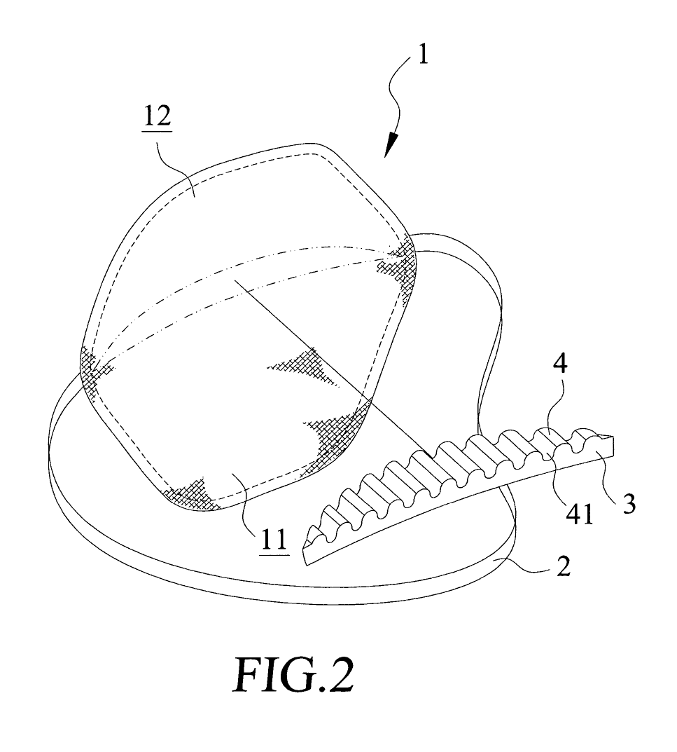

FIG. 2 is an exploded view of the mask of FIG. 1. Preferably, as shown in FIG. 2, the grooved section 4 extends from one end of the baffle 3 to the other end. Alternatively, the grooved section 4 may be formed at the middle section of the baffle 3.

Also, the baffle 3 is directly fixed to the inner side of the cover 1 by adhering, sewing or other appropriate way. Alternatively, the baffle 3 may be detachably fastened to the cover 1 by fastening means, and detached from the cover 1 when it is not required.

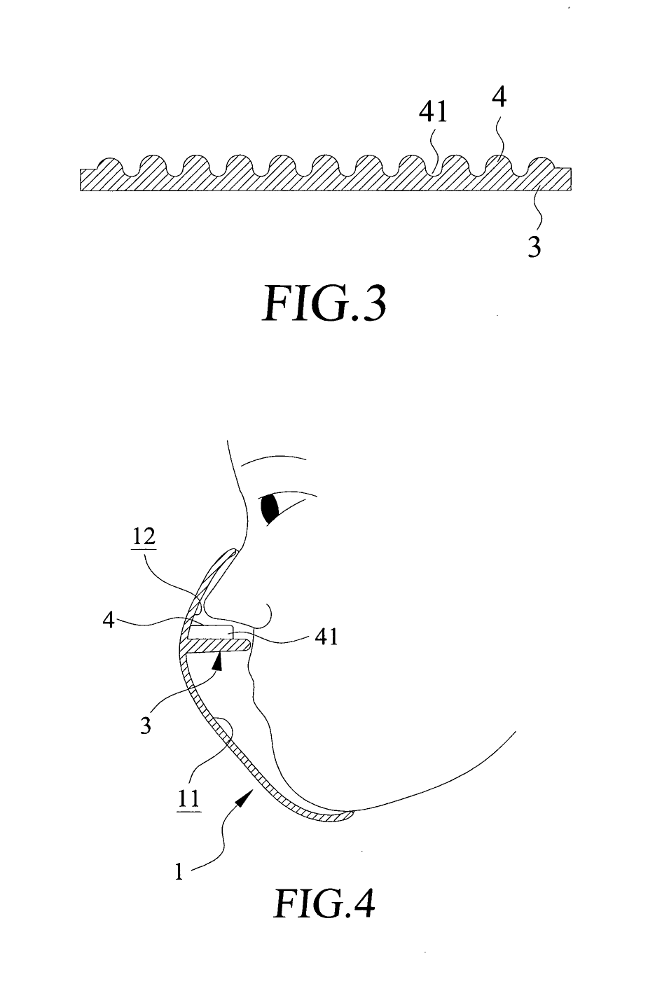

FIG. 3 is a sectional view showing the baffle of the mask, and FIG. 4 is side view showing a user puts on the mask. As shown, the grooves 41 of the grooved section 4 form air passages for flowing of air. The grooved section 4 has a wave shaped top and a flat bottom. When the user wears the mask, the grooved section 4 is positioned under the nose of the user. Air flows to the user's nose through the grooves 41. And, the baffle laterally and appropriately separates the cover 1 from the user's face, while the edge of the cover 1 is tightly pressed on the user's face. By means of the baffle 3, the user can breathe in air smoothly.

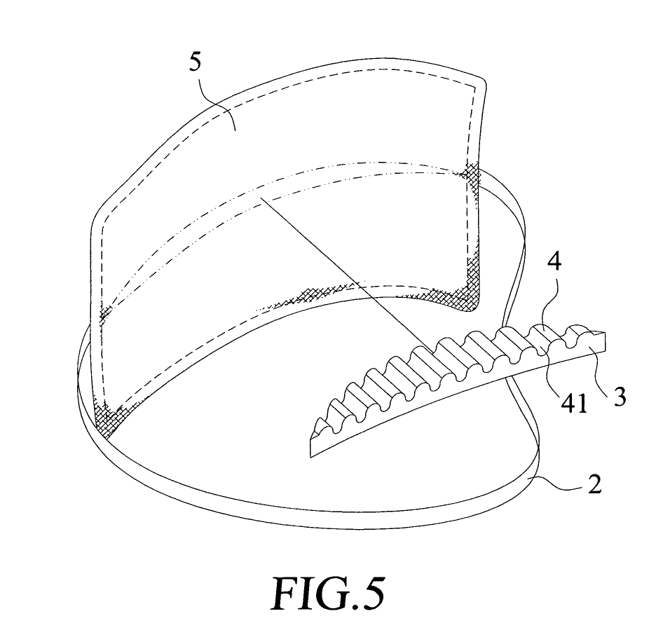

In the first embodiment, the mask has a fixed structure. The present invention may be modified to apply in a flat shape mask. Please refer to FIG. 5 which shows an exploded view of the second embodiment of the present invention. The mask comprises a flat shape cover 5, a strip 2, a baffle 3 which is formed with a grooved section 4. Similarly, the grooved section 4 comprises a plurality of grooves 41 for flowing of air. The baffle 3 can be fastened by any appropriate way to the cover 1, as mentioned above.

While the present invention has been described with reference to the specific embodiments, the description is illustrative of the invention and is not to be construed as limiting the invention. Therefore, various modifications to the present invention can be made to the preferred embodiments by those skilled in the art without departing from the true spirit and scope of the invention as defined by the appended claims.

1. A mask, comprising:
a cover;
a strip, which is connected to the cover for tightening the cover to the user; and
a baffle, which is mounted at an inner side of the cover and separates the cover into an upper part and a lower part, and the baffle is formed with a grooved section with at least one groove for air flowing therethrough.

2. The mask as claimed in claim 1, wherein the baffle has a wave shaped top and a flat bottom.

3. The mask as claimed in claim 1, wherein the grooved section extends from one end of the baffle to the other end.

4. The mask as claimed in claim 1, wherein when the user wears the mask, the baffle is positioned under the nose of the user, such that air flows smoothly to the user's nose through the at least one groove of the grooved section.

5. The mask as claimed in claim 1, wherein the cover has a fixed structure.

6. The mask as claimed in claim 1, wherein the cover has a foldable flat shape structure.

7. The mask as claimed in claim 1, wherein the baffle is directly fixed to the inner side of the cover.

8. The mask as claimed in claim 1, wherein the baffle is detachably fastened to the cover.
